(19) United States
(12) Patent Application Publication
(10) Pub. No.: US 2009/0261107 A1
(43) Pub. Date: Oct. 22, 2009

(54) MOTOR VEHICLE WITH A GAS TANK

(76) Inventors: Thorsten Allgeier, Untergruppenbach (DE); Kai Oertel, Stuttgart (DE); Stephan Leuthner, Leonberg (DE); Jan-Michael Graehn, Stuttgart (DE); Werner Gruenwald, Gerlingen (DE); Ian Faye, Stuttgart (DE)

Correspondence Address: MICHAEL J. STRIKER, 103 EAST NECK ROAD, HUNTINGTON, NY, 11743, US

(21) Appl. No.: 12/097,696

(22) PCT Filed: Dec. 18, 2006
(86) PCT No.: PCT/EP06/69845

§ 371 Date: Feb. 4, 2009

(30) Foreign Application Priority Data
Dec. 23, 2005 (DE) 10 2005 062 114.7

(51) Int. Cl. B62D 33/00; B65D 81/38

(52) U.S. Cl. 220/562; 220/592.01

(57) ABSTRACT

The invention proposes a vehicle (1) having a fuel cell system and/or an internal combustion engine and having at least one gas tank (2) for being filled with a gaseous fuel, in particular with natural gas or hydrogen, wherein a metal organic framework (MOF) is arranged in the interior of the gas tank (2) as a storage material for holding the fuel, wherein a comparatively high storage density is obtained and/or sufficient space for luggage or loading is made available in the vehicle (1). This is achieved according to the invention in that the gas tank (2) which comprises the metal organic framework (MOF) is embodied as a compressed-gas tank (2) for storing the gaseous fuel under pressure.

The present invention relates to a motor vehicle that is operated using gas as the energy carrier. The energy carrier may be, e.g., natural gas or hydrogen that is converted in a fuel cell or an internal combustion engine. A gas tank to be filled with a gaseous fuel, in particular natural gas or hydrogen, is provided, in the case of which a metal organic framework (MOF) is provided inside the gas tank, as the storage material for storing the fuel.

### RELATED ART

Natural gas (CH4) and hydrogen (H2) are becoming increasing significant as fuels for powering motor vehicles. A main disadvantage of these fuels is the relatively small volumetric storage density of these gases compared with liquid fuels.

Currently, gas tanks are designed as hollow containers and have pressures of, e.g., 200 bar (natural gas) or 350 to approximately 800 bar. “Metal-hydride reservoirs” are also already known. In this case, hydrogen is stored by forming a hydrate of suitable metals. These metals absorb hydrogen at low temperatures and release it when they are heated.

The disadvantage of these gas tanks, however, is that they take up a relatively large amount of space, which is greatly needed for use as trunk space or the like, and/or that they are relatively heavy compared with the quantity of fuel to be stored.

Materials are under development that could greatly improve these weak points. Metal organic frameworks (MOFs)—which are still in the developmental stage—are characterized by an extremely highly specific surface in the form of nanostructures, and they are capable of binding gases in high concentrations, via physisorption. MOF compounds are basically composed of metallic and organic molecules, which, taken together, form a very uniform crystal lattice. There is enough space available inside the lattice to absorb smaller molecules, e.g., hydrogen or methane, in the manner of a sponge. In initial experiments, it has proven possible to store hydrogen in MOFs in quantities of approximately two percent by weight. Gas tanks of this type therefore include a metal organic framework (MOF) in the interior, as the storage material.

### OBJECT AND ADVANTAGES OF THE INVENTION

The object of the present invention, therefore, is to provide a motor vehicle with a fuel cell system and/or an internal combustion engine and at least one gas tank to be filled with a gaseous fuel, in particular with natural gas or hydrogen, in the case of which a metal organic framework (MOF) is provided inside the gas tank, as the storage material for storing the fuel, and in the case of which a relatively high storage density is attained, and/or sufficient space remains in the vehicle for luggage or the like.

Based on a motor vehicle of the type described initially, this object is attained via the characterizing features of claim 1. Advantageous embodiments and refinements of the present inventions are made possible by the measures described in the subclaims.

Accordingly, an inventive motor vehicle is characterized by the fact that the gas tank that includes the metal organic framework (MOF) is designed as a compressed-gas tank for the compressed storage of the gaseous fuel, such as natural gas, hydrogen, or the like. The gaseous fuel is preferably bound in the gas tank or storage material via physisorption. This makes it possible to fuel the motor vehicle with a relatively high storage density of the gaseous fuel, to preferably store it in the gas tank and motor vehicle, and to subsequently consume it as needed.

It is also possible to adapt the shape of the gas tank in a flexible, advantageous manner to the particular conditions and/or applications.

The compressed-gas tank preferably includes at least two sub-tanks, with the sum of the separate sub-tank volumes essentially corresponding to the total storage volume of the compressed-gas tank. The total storage volume may therefore be subdivided in an advantageous manner. As a result, the total storage volume may be advantageously adapted to the available space or possible locations in a motor vehicle in particular. For example, a tank may be located in the rear and/or front and/or center and/or in the roof and/or in the floor of the motor vehicle. A flexible distribution of the total storage volume of this type may result primarily in minimizing or even eliminating the need to use the trunk space to store fuel.

In general, it is feasible, according to the present invention, to locate the trunk of the motor vehicle that includes a fuel cell system in the rear, as usual, but also in the front of the vehicle.

In a particular refinement of the present invention, at least one connecting line is provided between the at least two sub-tanks, through which the gaseous fuel flows. Via this design, it is easily made possible to connect the entire storage volume with the fuel cell system, e.g., using a common line. This makes it possible to advantageously manage the gaseous fuel stored in the gas tank during operation and/or while the motor vehicle is being driven.

Advantageously, the contours of the compressed-gas tank and/or at least one of the sub-tanks is at least partially tailored to a cavity in the motor vehicle and/or to the contour of the motor vehicle. It is thereby ensured that the spacial expansion of the compressed-gas tank and/or one of the sub-tanks may be adapted, advantageously, to the empty space available in the motor vehicle and/or to the outer contour of the motor vehicle and/or to the inner contours of the motor vehicle. Accommodating the compressed-gas tank and/or the sub-tank in the motor vehicle is made decisively simpler as a result.

A gas tank is located, e.g., in a door and/or a double-walled floor and/or roof, etc. Advantageously, the compressed-gas tank and/or one of the sub-tanks are/is located, e.g., in the body and/or chassis that are/is designed to be particularly robust. As a result, it is also possible, according to the present invention, to utilize the vehicle body and/or chassis to realize a protection function and/or support function for the gas tank.

In an advantageous embodiment of the present invention, the compressed-gas tank and/or at least one of the sub-tanks includes at least two wall surfaces that are essentially plane-parallel, and/or that are located at angles to each other or such that they form a wedge. A compressed-gas tank and/or sub-tank of this type is relatively easy to manufacture, thereby resulting in relatively low costs. A gas tank of this type may also be accommodated in a particularly space-saving manner.

The compressed-gas tank and/or at least one of the sub-tanks is preferably designed essentially in the shape of a prism, in particular in the shape of a cuboid or the like. Compressed-gas tanks and/or sub-tanks with this type of design are particularly easy to manufacture and install.

Advantageously, the compressed-gas tank and/or at least one of the sub-tanks is located at least in the region between and/or underneath the vehicle seats and/or at least in a seatback of the motor vehicle seat and/or in the region of the motor vehicle roof. The compressed-gas tank and/or one of the sub-tanks may be advantageously accommodated in locations such as these without losing valuable space, e.g., in the trunk of the motor vehicle. Via the accommodation in the aforementioned locations in the motor vehicle, it may also be possible to further enhance the reinforcing function of the vehicle body.

In a particular refinement of the present invention, a support unit for supporting the wall surfaces is provided at least in the interior of the compressed-gas reservoir. The support unit is designed, in particular, to absorb tensile forces, thereby making it possible to absorb a relatively high pressure of the gaseous fuel. Using a support unit of this type and according to the present invention, the pressure of the gaseous fuel may be designed to be relatively great without the need to design the walls of the compressed-gas tank to be particularly thick or massive. As a result, the aforementioned shape may also be easily realized as a prism, a cuboid, or as having plane-parallel wall surfaces, and/or to tailor it to the cavity in the motor vehicle and/or to the contour of the motor vehicle.

It is basically advantageous to design the compressed-gas tank according to the present invention such that the shape may be designed and/or selected as needed.

The support unit of the compressed-gas tank is preferably designed with a honeycomb structure. For example, the honeycomb structure includes intermediate spaces that are polygonal in shape, and, in particular, square, hexagonal, and/or octogonal in shape, in which the storage material and/or the metal organic framework (MOF) is stored and/or located. Honeycomb structures of this type have proven particularly advantageous for absorbing pressures that are generated by the gaseous fuel.

In general, and according to the present invention, support elements or devices, or reinforcing elements or devices may be provided on the exterior of the gas tank. They may serve to make the gas tank more pressure-resistant, as an alternative to or in combination with the aforementioned support unit. These support elements or devices, or reinforcing elements or devices are designed, e.g., as thicker regions on the exterior of the gas tank, and/or as elements of the vehicle body and/or chassis.

In an advantageous variant of the present invention, a heating unit and/or a cooling unit for heating and/or cooling the compressed-gas tank and/or the sub-tank are/is provided at least in the interior of the compression-adsorption gas tank and/or the compressed-gas tank and/or at least one of the sub-tanks. A heating fluid and/or cooling fluid, e.g., a process water or the like, is preferably provided As an alternative or in combination therewith, heat pipes may also be used to attain particularly effective thermal management. As a result of the inventive heating, the compressed-gas tank and/or the sub-tanks may be controlled thermostatically in a simple manner. An electronic control unit is preferably used to control the operating temperature of the compressed-gas tank and/or the sub-tanks.

The pressure of the fuel is preferably greater than 10 bar and/or less than 350 bar and/or less than 50 bar, at least during normal operation. It has been shown that high storage densities may be realized at these operating pressures.

Basically, by using a compressed-gas tank according to the present invention, the shape of the compressed-gas tank may be chosen to be so flat that it may be accommodated in any location in the motor vehicle, e.g., in the floor of the motor vehicle, without the need to make any significant design changes to the other vehicle components, which may be conventional or commonly available, and without impairing their function. As a result, e.g., the vehicle design is greatly simplified, and the costs to realize the present invention are reduced.

### EXEMPLARY EMBODIMENT

An exemplary embodiment of the present invention is shown in the drawing and is described in greater detail below with reference to the figures.

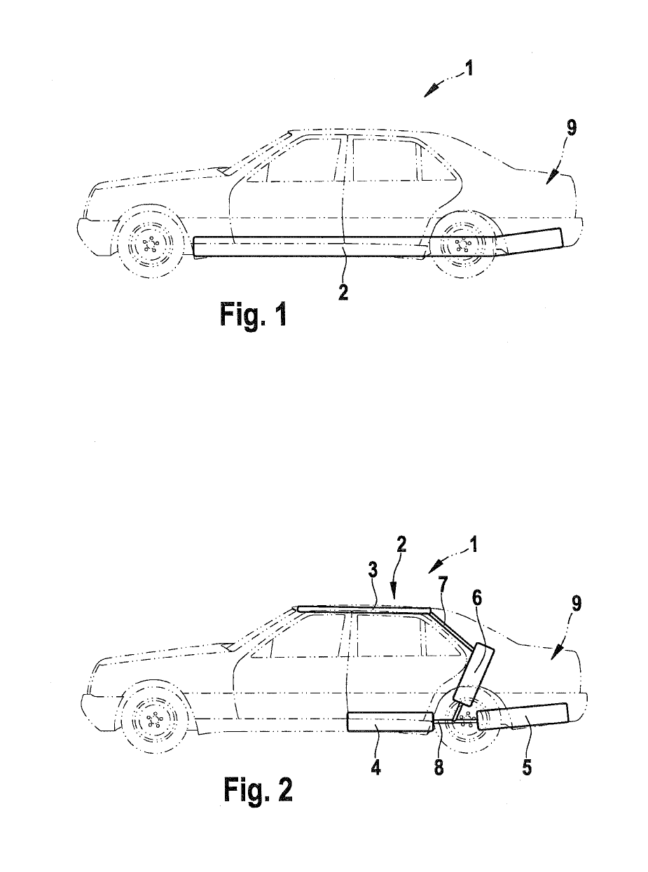

FIG. 1 shows a schematic depiction of a compressed-gas tank according to the present invention, that is located at the bottom of the motor vehicle, and

FIG. 2 shows a schematic view of a compressed-gas tank according to the present invention, that is subdivided into several interconnected sub-tanks.

FIG. 1 shows a vehicle 1 according to the present invention, in the case of which a compressed-gas tank 2 is located in the floor region of vehicle 1.

FIG. 2 shows a possible distribution of compressed-gas tank 2 according to the present invention into several interconnected sub-tanks 3, 4, 5, 6. The sub-tanks are advantageously connected by lines 7, 8 or tubes 7, 8, thereby making it possible to supply the entire storage volume to the motor for direct combustion via a single outlet opening in the fuel cell system or fuel cell stack.

For clarity, the figures do not show further components, in particular of the fuel cell system, fuel cell stack, engine drive, etc.

The figures make it clear that sub-tanks 3 through 6 or compressed-gas tank 2 may be designed, e.g., as two plan-parallel wall surfaces or essentially as a cuboid with optionally rounded edges or the like, and that it may be located in motor vehicle 1 in an advantageous manner. Sub-tank 3 is located, e.g., in the ceiling of the motor vehicle, and may therefore further reinforce the ceiling. The same applies for sub-tanks 4, 5, 6 and compressed-gas tank 2.

The figures also make it clear that a trunk 9 and/or its volume are/is relatively uncompromised by compressed-gas tank 2 and/or sub-tanks 3 through 6.

What is claimed is:

1. A motor vehicle with a fuel cell system and/or an internal combustion engine, and at least one gas tank (2 through 6) to be filled with a gaseous fuel, in particular with natural gas or hydrogen, with a metal organic framework (MOF) being located inside the gas tank (2 through 6), as the storage material for storing the fuel,
wherein
the gas tank (2 through 6), which includes the metal organic framework (MOF), is designed as a compressed-gas tank (2 through 6) for storing the gaseous fuel under compression.

2. The motor vehicle as recited in claim 1,
wherein
the compressed-gas tank (2) includes at least two sub-tanks (3 through 6), with the sum of the at least two, essentially separate sub-tank volumes essentially corresponding to the total storage volume of the compressed-gas tank (2).

3. The motor vehicle as recited in claim 1,
wherein
at least one connecting line (7, 8) is provided between the at least two sub-tanks (3 through 6), through which the gaseous fuel flows.

4. The motor vehicle as recited in claim 1,
wherein
the contours of the compressed-gas tank (2) and/or at least one of the sub-tanks (3 through 6) are at least partially tailored to a cavity in the motor vehicle and/or the contour of the motor vehicle.

5. The motor vehicle as recited in claim 1,
wherein
the compressed-gas tank (2) and/or at least one of the sub-tanks (3 through 6) includes at least two essentially plane-parallel wall surfaces.

6. The motor vehicle as recited in claim 1,
wherein
the compressed-gas tank (2) and/or at least one of the sub-tanks (3 through 6) includes at least two planar wall surfaces that are located essentially at an angle with each other.

7. The motor vehicle as recited in claim 1,
wherein
the compressed-gas tank (2) and/or at least one of the sub-tanks (3 through 6) are/is shaped essentially like a prism.

8. The motor vehicle as recited in claim 1,
wherein
the compressed-gas tank (2) and/or at least one of the sub-tanks (3 through 6) are/is essentially cuboid in shape.

9. The motor vehicle as recited in claim 1,
wherein
the compressed-gas tank (2) and/or at least one of the sub-tanks (3 through 6) are/is located at least in the region between and/or underneath the vehicle seats.

10. The motor vehicle as recited in claim 1,
wherein
the compressed-gas tank (2) and/or at least one of the sub-tanks (3 through 6) are/is located at least in a seatback of a vehicle seat.

11. The motor vehicle as recited in claim 1,
wherein
the compressed-gas tank (2) and/or at least one of the sub-tanks (3 through 6) are/is located in the region of the vehicle roof.

12. The vehicle as recited in claim 1,
wherein
a support unit is provided inside the compressed-gas tank (2 through 6) for supporting the wall surfaces.

13. The motor vehicle as recited in claim 1,
wherein
a heating unit and/or a cooling unit are/is provided at least in the interior of the compressed-gas tank (2 through 6) for heating and/or cooling the compressed-gas tank (2 through 6).

14. The motor vehicle as recited in claim 1,
wherein
the pressure of the fuel is greater than 10 bar, at least during normal operation.

15. The motor vehicle as recited in claim 1,
wherein
the pressure of the fuel is less than 250 bar, at least during normal operation.

16. The motor vehicle as recited in claim 1,
wherein
the pressure of the fuel is less than 50 bar, at least during normal operation.
